(19) United States
(12) Patent Application Publication
(10) Pub. No.: US 2012/0049009 A1
(43) Pub. Date: Mar. 1, 2012

(54) Integral Powered Winged Aircraft for Infantry and Artillery Mobilization and Front Line Combat

(76) Inventor: Waldemar F. Kissel, JR., Gainesville, FL (US)

(21) Appl. No.: 13/118,509

(22) Filed: May 30, 2011

Related U.S. Application Data
(63) Continuation-in-part of application No. 12/501,971, filed on Jul. 13, 2009, now Pat. No. 7,950,603.
Application No. 12/501,971 is a division of application No. 11/521,597, filed on Sep. 14, 2006, now Pat. No. 7,559,506.
(60) Provisional application No. 60/717,145, filed on Sep. 14, 2005.

(51) Int. Cl. B64C 39/06

(52) U.S. Cl. 244/23 C

(57) ABSTRACT

Disclosed is a Powered Wing Aircraft. A generalized stabilizer/directional vent is used for providing a standard range of aeronautical control. It controls cross winds, directional velocity, directional control, and torque balancing in one simple easy to control device. It is attached to the axles. These improvements can apply to both military and civilian applications.

### CROSS REFERENCE TO RELATED APPLICATIONS

This application claims priority to and is a continuation-in-part of application Ser. No. 12/501,971 filed on Jul. 13, 2009 and entitled “Integral Powered Wing Aircraft.” The '971 application is a divisional of and claims priority to application Ser. No. 11/521,597 filed on Sep. 14, 2006 and entitled “Integral Powered Wing Aircraft” (now U.S. Pat. No. 7,559,506). The '597 application, in turn, claims priority to provisional application Ser. No. 60/717,145 filed on Sep. 14, 2005 entitled. “Integral Powered Wine Aircraft.” The contents of all the foregoing applications are fully incorporated herein by reference for all purposes.

### BACKGROUND OF THE INVENTION

1. Field of the Invention

This application relates to an integral powered winged aircraft (or “IPWA”). More specifically, the present invention relates to an aircraft design consisting of two concentrically oriented contra-rotating discs, whereby rotational forces generated by the discs are equal and opposition to each other such that a central axis remains fixed.

2. Description of the Background Art

Today's military is frequently engaged in a new class of warfare for infantry and light artillery. Often the infantry and light artillery must engage an unsophisticated enemy using guerilla tactics. The primary military problem is the mismatch between quality of targets and cost of destroying low value targets and the high level of casualties inflicted by relatively unsophisticated weapons. A guerilla army may usually be equipped with basic hand weapons, howitzers, rocket propelled grenades, improvised explosive devices, and surface to air missiles fired from the back of a pick up truck. All are relatively inexpensive. These crude weapons such as IED's (Improvised Explosive Devices) inflict heavy casualties.

A shoulder mounted RPG can be fired by a barefoot teen fighter and destroy a Abrams M-1 main battle tank and inflict catastrophic damage to the crew inside. A surface to air missile from a pick up truck can bring down a Blackhawk helicopter worth $16 to 20 MM, or a $60 to $100 MM fighter plane. A billion dollar stealth aircraft may be less vulnerable to attack, but just putting it in combat exposes it to a certain statistical risk of destruction from mechanical failure.

Why are these costly and sophisticated weapons exposed or put in harms way against such low level targets? These aircraft are better reserved for risk against targets worth billions of dollars such as a nuclear facility or aircraft manufacturing plant. A fighter aircraft consumes several thousand gallons of fuel each day. A drone launches a smart missile or bomb against a target worth little value, the smart missile may cost several hundred thousand dollars. It quickly becomes very costly to fight an unconventional enemy while using very costly weapons that were designed for use against sophisticated forces.

The reason such costly and sophisticated weapons are used is because a less costly, yet effective, system of weaponry has not been developed.

### SUMMARY OF THE INVENTION

It is an objective of this invention to minimize the use of mounting arms to restrain the concentric discs of the IPWA. It has been determined that the cross section width of the discs can be made very rigid. The outer disc will run in a bearing race around the outer edge of the inner concentric circle.

It is also object of this invention to create a generalized directional stabilizer vent that can be used with all IPWAs and can control or compensate for most of the aeronautic forces acting on the aircraft.

It is a further objective of this disclosure to add numerous technical improvements to enhance the performance of IPWAs, to arrange for the use of various power sources, arrange for compartments to carry soldiers or civilians, and create an embodiment that can operate and fight effectively sitting on water, on land, or traveling in the air.

It is an object of this invention to create a vehicle that can replace the HUMMER or HUMMVEE as a basic front line combat vehicle and which will protect infantry soldiers from attacks by an enemy using improvised explosive devices.

It is an objective of this invention to disclose a complete series of military vehicle embodiments for the specific purpose of mobilizing the infantry (foot soldier) and their artillery for use in all combat operations.

It is yet another object of this invention to disclose a stationary hardened defensive shelter that will protect friendly personnel from attacks by enemy IPWAs who may use tactics that will be disclosed herein.

It is an objective of the present disclosure to identify a plurality of aerodynamic forces that impact the aircraft and its performance capabilities.

It is an objective of this disclosure to present a plurality of alternate or simultaneously acting means to balance the counter torques of the IPWAs.

It is an objective of this disclosure to improve the aerodynamics and performance of the prior art.

It is an objective of this disclosure to demonstrate how the IPWA military embodiments herein create a new process or procedure for conducting military operations.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE SEVERAL VIEWS OF THE DRAWINGS

FIG. 1—Top view of basic IPWA identifying several aerodynamic forces which act on the vehicle and must be counteracted, controlled or converted to the vehicle advantage.

FIG. 2—Bottom view of basic IPWA identifying several aerodynamic forces which act on the vehicle and must be counteracted, controlled or converted to the vehicle advantage.

FIG. 3—A IPWA Block Diagram showing arrangement of major components.

FIG. 4 (A-H)—Identifies the major components and features of a basic IPWA.

FIG. 5—Generalized Stabilizer/Directional Vent Top View.

FIG. 6—Several Views showing the relationships between the Outer Disc, Inner Disc, Integral Generalized Stabilizer/Directional Vent, Bearings, Electromagnetic Motor, and Electric Supply.

FIG. 7—An alternative embodiment of an IPWA.

FIG. 8—An alternative embodiment of an IPWA.

FIG. 9—An alternative embodiment of an IPWA; Unmanned Light Gunship and Logistics IPWA.

FIG. 10—An alternative embodiment of an IPWA; AAAMV-HAG (Airborne Armored Artillery Mobilization Vehicle-Heavy Artillery Gunship)

FIG. 11—An alternative embodiment of an IPWA; AAIMVee (Airborne Armored Infantry Mobilization Vehicle)

FIG. 12—An alternative embodiment of an IPWA; AAIMPCLC (Airborne Armored Infantry Mobilization-Personnel Carrier and Landing Craft)

FIG. 13—I An alternative embodiment of an IPWA; AALVee (Airborne Artillery Logistics Vehicle)

FIG. 14—An alternative embodiment of an IPWA.

FIG. 15—An alternative embodiment of an IPWA.

Similar reference characters refer to similar parts throughout the several views of the drawings.

### DETAILED DESCRIPTION OF THE INVENTION

The present invention relates to an integral powered winged aircraft or “IPWA.” More specifically, the invention relates to an aircraft wherein lift is generated by two discs which rotate about a central axis. The discs generate equal and opposite forces such that the central axis remains fixed, thereby allowing it to be used for a crew or cargo compartment. In one embodiment, the two discs are concentrically located. The various components of the present invention, and the manner in which they interrelate, will be described in greater detail hereinafter.

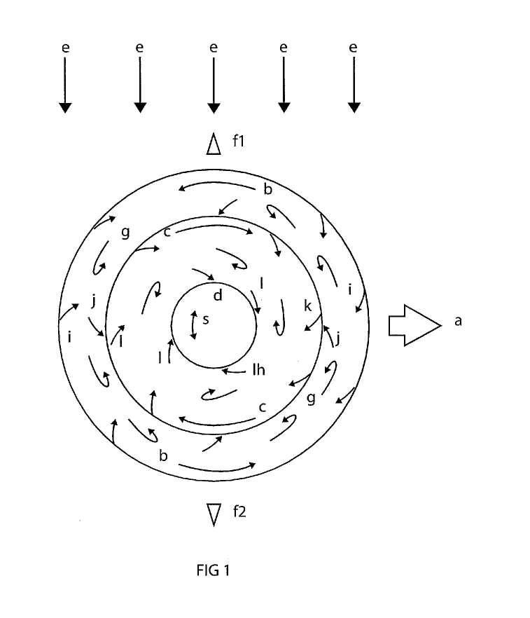

FIG. 1 is a top view of an IPWA which shows the general location of the aerodynamic forces which act on the vehicle and must be counteracted, controlled, or converted to the vehicle advantage. In FIG. 1 “a” is the direction of travel, “b” is outer disc direction of rotation, “c” is the inner disc direction of rotation, “d” is the non-rotating canopy that closes the aperture in the center of the inner disc, “e” is a crosswind. Additionally, “f2” and “f1” are the cross track forces caused by the Lateral Rotational Motion Imbalance. Items “g” and “h” are the lifting forces created by the Surface Vents that provide lift like the leading airfoil edge of a plane wing that also serves to create a Down Draft as it scoops air into intake vents and forces it to the underside of the disc. Arrows “i,” “j,” and “k” are all air flows created by raised ridge contours on the surface of the rotating discs that divert surface air toward inlets. Arrow “l” represents the air flow created by Contouring Ridges to divert air flow under the outside edge of the canopy “d.”

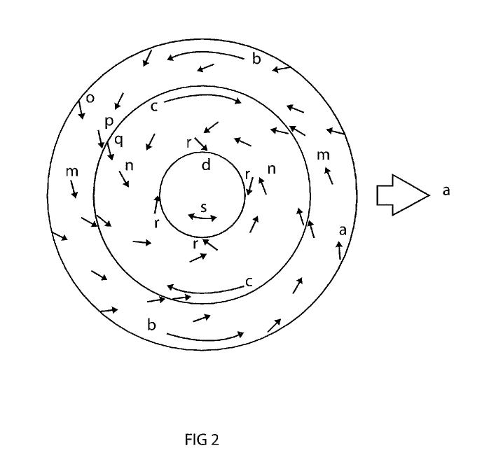

FIG. 2 shows the forces acting on the bottom side of a basic IPWA. In FIG. 2 items “m” and “n” illustrate the upward lifting force created by Wind Surfing. Item “o” is an air curtain created by surface vents on the leading edge of the outer disc that forces air toward the center and downward with maximum velocity, a strong air curtain will increase the overall pressure under the discs and increase lift. Items “p” “q,” and “r” are air flows on the underside of the rotating discs caused by Wind Contouring. Item “s” is the involuntary random oscillation of the canopy, central axis and gondola clockwise and counterclockwise due to Contra Rotating Torque Imbalance created by opposing forces. These are most of the aerodynamic forces acting on or being created by the vehicle. These are to be determined and optimized using mathematical analysis, computer simulation and wind tunnel testing using aerodynamic formulas and facilities known in the industry.

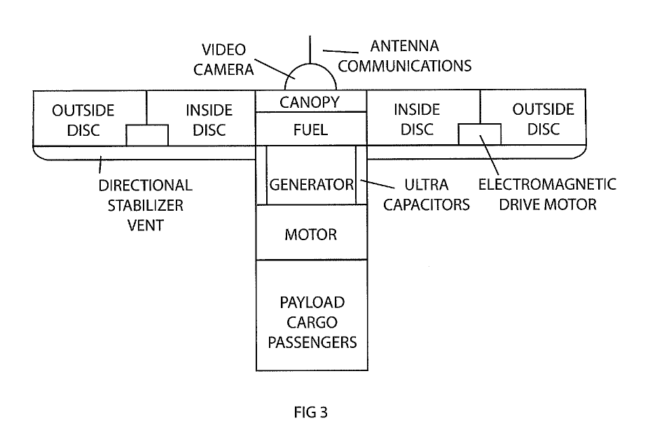

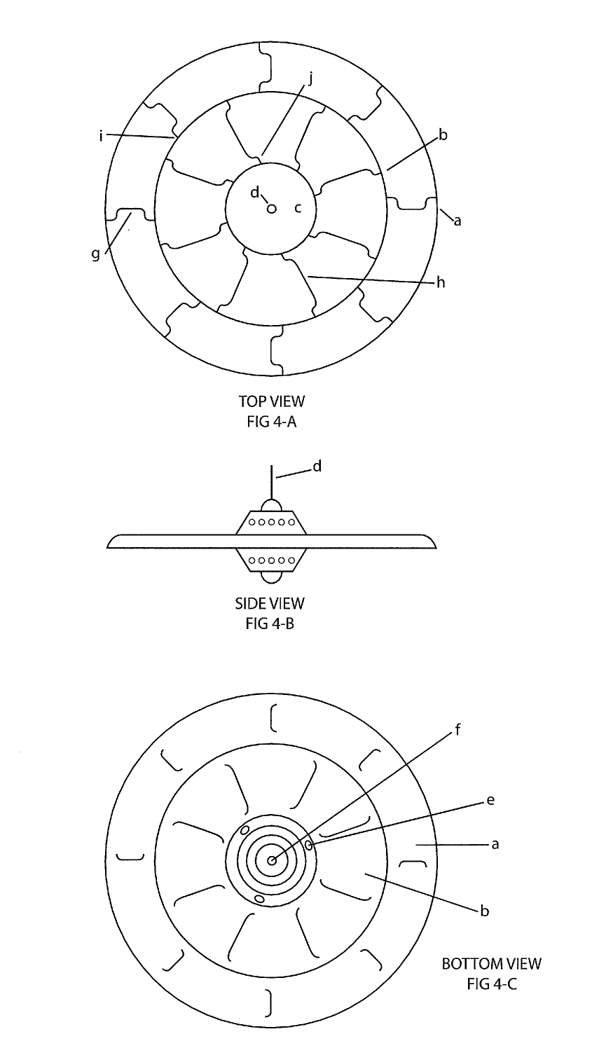

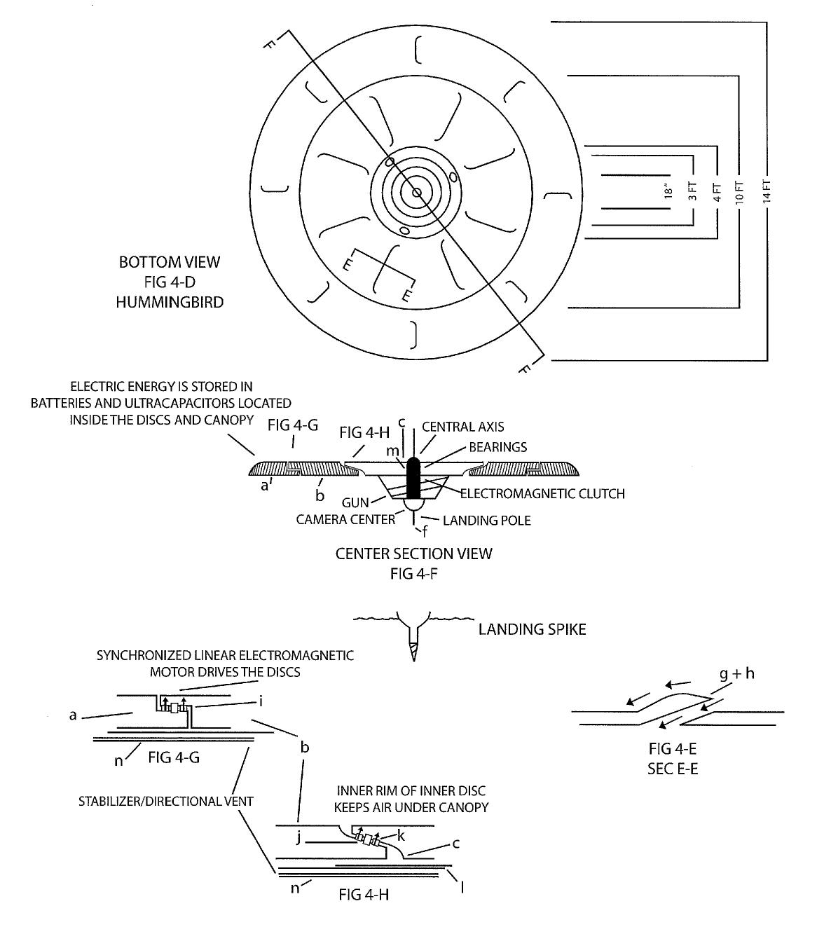

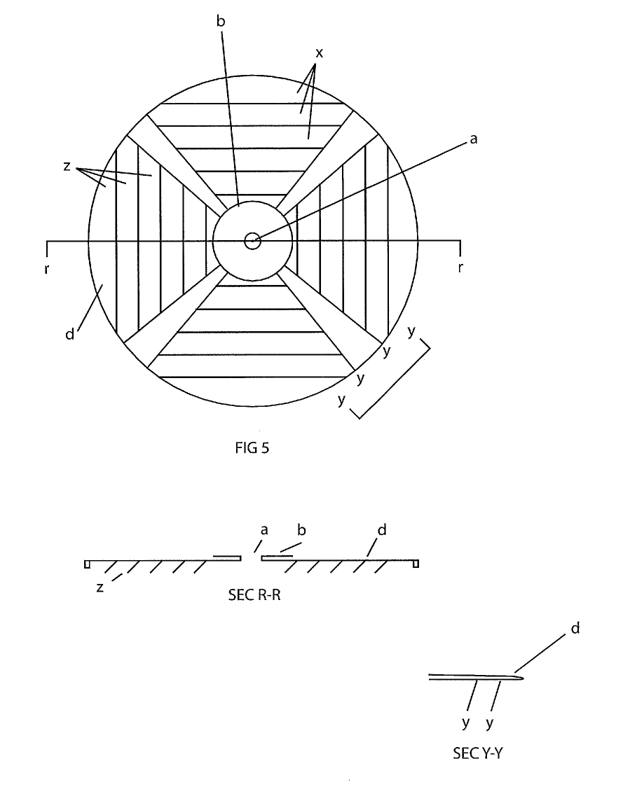

FIG. 3 shows a block diagram of a generalized IPWA. All IPWAs will usually have this arrangement. FIG. 4 shows the top, bottom, side and section view of a basic IPWA in its preferred embodiment. In FIG. 4-A, “a” is the outer disc, “b” is the inner disc, “c” is the canopy, “d” is the antenna for transmitting video and audio to a relay station such as a satellite, drone, or airship and on to a control center. The IPWAs are all always under control of a central control center even when occupied by an operator. Central control may defer command selectively to a vehicle operator occupant. FIG. 4-C “e” is a set of ground sensors that enable the IPWA to travel a few inches above ground, “f” is one form of landing gear for the basic IPWA, “g” is the Lifting Surface Vents on the outer disc, “g” begins with an edge inlet with a diverter wind scoop that comes around to the surface, diverts air into the port, creating lift with air flowing over the top and then a Wind Contouring Ridge “i” that directs the air toward the inner disc, “h” is the Lifting Surface Vents on the inner disc. The raised ridges divert air flow into the Lifting Surface Vents port and continue on to the Draft Diverter “j” that forces air under the canopy “c.” FIG. 4-C is a bottom view of a basic IPWA. Aeronautic analysis, simulation, and wind tunnel testing would be used to contour the wind surfing effect as the discs rotate and drive the air under the discs toward the center of the vehicle.

FIG. 4-D suggests some dimensions for the vehicle although it is understood IPWA dimensions could be much smaller or much larger in diameter and thickness. Section E-E shows a cross section through a Lifting Surface Vent in FIG. 4-E. FIG. 4-F shows a section F-F through the center of the vehicle. Notice the lower lip on the inside edge of the outer disc “a” is under the upper lip of the outer edge of inner disc “b.” The outer disc is required to be rotating faster than the inner disc and sized such that it will create a lifting force “i” on the inner disc. This is shown in more detail in FIG. 4-G. In this embodiment, the outer disc is rigid and transfers its lift to the inner disc. In FIG. 4-H the inner disc “b” transfers its lift to the non-rotating canopy “c.” There may be an electromagnetic reversible electric motor “j” to use to balance counter rotation and two bearings “k” on each side of “j,” to transfer the force. There is still a set of mounting arms “l” that connect to the inner edge of the inner disc on one end and to triple concentric bearings “m” on the other end. These mounting arms are used to center balance the inner disc. The outer disc is centered on the inner disc. FIG. 4-G and FIG. 4-H show the Generalized Directional/Stabilizer Vent “n” below the discs.

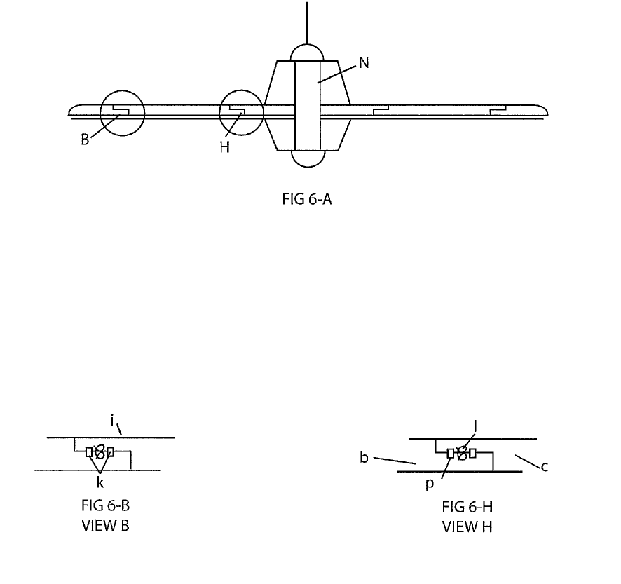

In FIG. 5 “a” is the axle shaft opening, “b” is a structural disc, “d” is the outer structural rim of the Generalized Directional Stabilizer Vent, “x” are the oscillating vanes that control cross track, cross wind, and any other forces at right angles to the direction of travel, “z” are the oscillating vanes that control the VELOCITY of the vehicle. When the vanes are vertical the vehicle is hovering, or climbing vertically or descending. When the vanes are at an angle the vehicle will move in the direction opposite the angle. If the vanes are closed the vehicle will drop out of the sky. The Stabilizer Vane “y” is one of the ways Rotational Motion of the fuselage of the vehicle due to imbalanced torque/bearing friction forces is neutralized so the vehicle does not rotate. This Stabilizer Vane “y” is the primary means for steering the vehicle, or controlling the direction of travel. In FIG. 6-A the “N” is the central axle of the vehicle, “M” is the Generalized Stabilizer Directional Vent, “o” are the cameras, “p” is the antenna, “a” is the outer disc, “b” is the inner disc and “c” is the canopy. In FIG. 6-H VIEW-H where the inner edge of the inner disc “b” interfaces with the outer edge of the Canopy “c” there are bearings “p” to maintain a preferred separation, but a reversible electromagnetic motor “l” located between them can be used as a back up means to counter rotational motion and steer the vehicles. In general, any imbalance in rotation by the outer and inner discs can be countered at any location where there is differential friction.

The Generalized Stabilizer Directional Vent in FIG. 5 is used on IPWAs that have mounting arms on both the outer and inner discs.

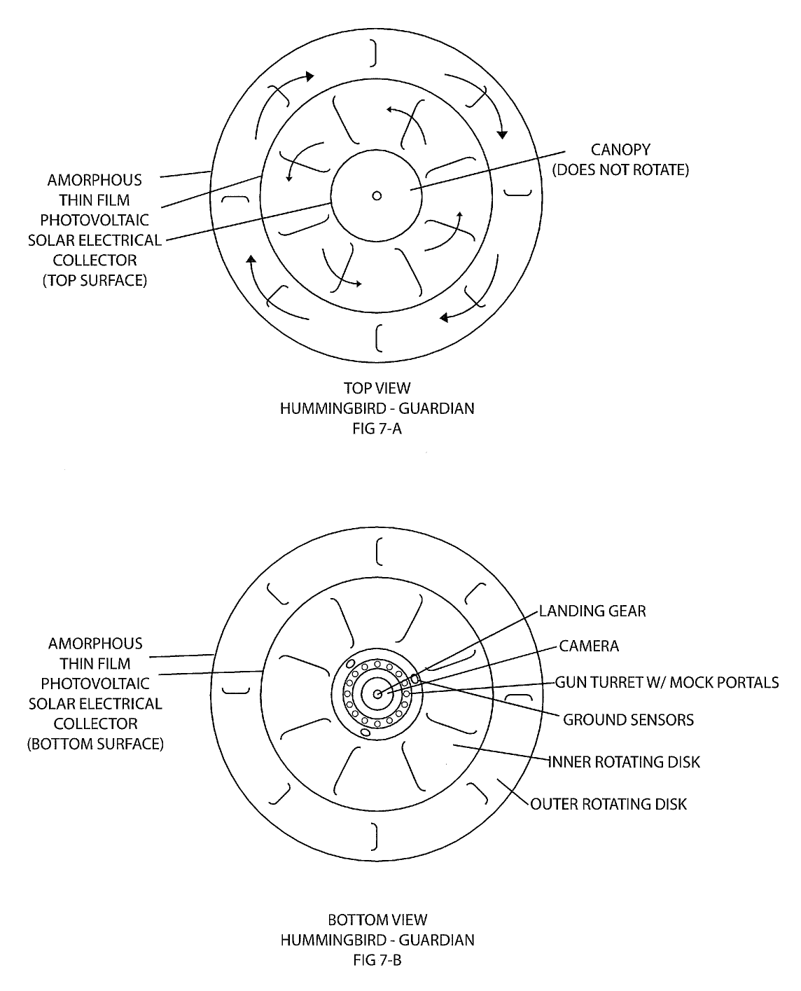

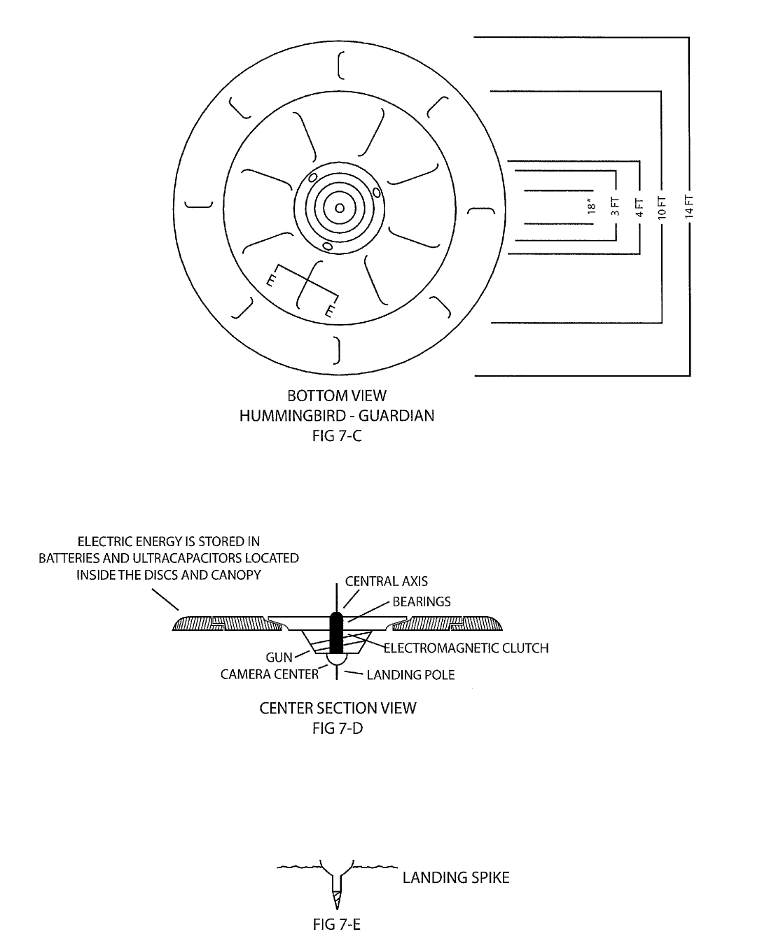

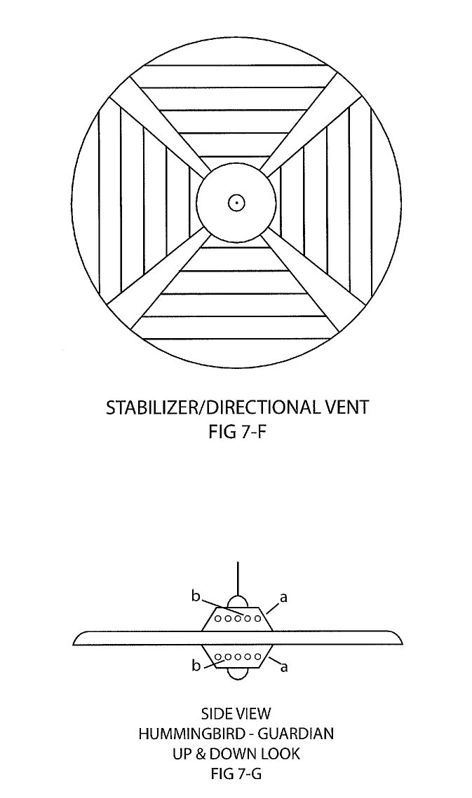

The first military embodiment application of the IPWA is called the Guardian illustrated in FIG. 7 (A thru G).

The Guardian is an unmanned vehicle approximately 14 foot in diameter, two counter rotating discs, closed canopy disc aperture, power supplied by photo cells on surface charging energy storage devices inside the discs, optional ultracapacitors, exterior rapid charging input options, has mounting arms on both outer and inner discs, uses the Generalized Stabilizer/Directional Vent (FIG. 7-F) to control vehicle. It has standard landing gear and ground sensors (FIG. 7-B). It has hemispherical cameras above and below the canopy and antenna for transmitting pictures, navigation and other transmissions to a remote control center. This is all part of a basic IPWA preferred embodiment. To turn it into a Guardian it has multi-portal gun turrets, one above and one below the canopy FIG. 7-G. All the portals “a” in each turret are mock portals except one. There is an automatic firing gun “b,” operated from a remote control center that fires single rounds in rapid succession. The gun is large caliber, has accuracy at long and close range. It is not intended to be a Gatling or machine gun. It is intended to be comparable to a hand rifle such as an infantryman might carry. It is one bullet, one target, one shot per target. Unlike a live soldier, the Guardian is not concerned about being fired on while it takes aim. The Guardian may be firing almost point blank in many cases. When taking aim the cameras have better, sharper, more detailed vision than the best human eye. The cameras can see colors and wavelengths that a human cannot. The cameras can see in the dark. The cameras can zoom in on a target hundreds of yards away. The cameras can sort out differential movement in its field of vision. The cameras can see behind, on both sides and above as well as straight ahead. These vision features apply to all the military embodiments that will be disclosed.

The Landing Pole in FIG. 7-D is attached on top of, or in lieu of, the standard landing gear and locks into the Landing Spike FIG. 7-E. The Guardian is a lightweight vehicle that will be standing on guard (patrolling) in all kinds of weather and conditions. There are strong winds, deep snow, drifting sand storms, extreme locations perched high up on a rock ledge on mountains. The Guardian needs a strong support that may need to be several feet tall to stay above drifting snow or sand. The landing spike may need to be drilled or pounded into the ground, or fixed with epoxy adhesives to the faces of rocks and mountain cliffs. In extreme cold the Guardian has a built in heating element to melt snow from the cameras. During a blizzard or snowstorm the Guardian will activate its discs to rotate in place to prevent snow and ice from accumulating. The discs may use built in deicers that will prevent sleet or freezing rain from accumulating or sticking to the Guardian's already non-stick polished surfaces.

The concept of operation for the Guardian vehicle is as a sentry. For example, the mission may be to set up a continuous border security the entire length of the boundary between Afghanistan and Pakistan. The goal is visual capability to see any person or vehicle that attempts to cross this border. Suppose the border is 900 miles long. The guard posts do not have to be on the exact legal boundary. The posts can be moved in to where there are longer stretches of clear vision with fewer trees, hills, buildings, or other obstructives. The Guardian has great vision at least 500 plus feet in all directions, so five Guardians are needed per mile, or 4500 Guardians are required to seal the border. The Guardians will sit there and watch in all directions, never distracted, day and night, everyday of the week, never tired, never hungry, never needing a toilet break, never cold or hot, never needing refueling, never complaining, and looking very intimidating. It would require 22,500 soldiers plus 4500 Humvees, and lots of supplies to do this job, if just one soldier were kept on post where each Guardian is at. If anyone approaches the border, a Guardian would fly over to question whoever was involved and could execute appropriate action.

Along the United States/Mexico border there are fences, cameras, border guards, but there are still drug dealers and potential terrorists who may get through. Guardians could be stationed on hill sides and strategic locations, or they could fly regular patrols. Some ranchers have been killed and homes burglarized by border intruders. Some Guardians could be posted around private property. The Guardian could bolster homeland security. In guerilla warfare, such as in recent years, guarding mountain passes appears to have been a problem. Guardians could be stationed on the most inaccessible mountain scapes to watch mountain passes. Again, Guardians replenish their energy every day. They can operate in remote locations for indefinite periods with very little human intervention other than needing maintenance and more ammunition.

The Guardian can be used during combat to secure the ever changing perimeter of the advancing IPWA Swarm that will be further disclosed herein.

Guardians can be used to watch the poppy fields in Afghanistan or wherever, and call in drug enforcement agents when the growers show up to check out the crop.

The Guardian is seen as a front line combat participant when the situation demands military interdiction. However, the Guardian is a more expensive vehicle, so it would not be the first vehicle used in everyday combat situations. If a Guardian were to somehow be over run or ambushed by enemy forces, it would be equipped to blow itself up on command.

The following concept illustrates how the IPWA, using a variety of embodiments, creates a more effective, open field of battle, combat force that reduces friendly casualties particularly casualties caused by IED's and reduces the cost of conducting limited warfare against enemy forces that are using guerilla tactics, that is, using hand held, high impact, low cost weapons like IED's and RPG's. However, the IPWA Combat Vehicles will be able to handily knock out enemy tanks, heavy artillery, helicopter, fighter aircraft, drones, radar, and missile launchers such as a third world renegade military power may have in its arsenal.

The front line combat vehicles to be described include the LOCUST (the basic unmanned equivalent of an infantry man on foot), FIREFLY (the basic unmanned equivalent of a light armored vehicle such as an armed Humvee), DRAGONFLY (a heavily armed unmanned gunship, the basic equivalent of a MAIN BATTLE TANK, or BLACKHAWK HELICOPTER equipped with a wide array of possible weapons). These would be the vehicles placed directly in harms way to engage in the actual combat. Supporting vehicles include the AAIMVee which is a flying HUMVee that carries up to four (4) soldiers each for supervising the combat operation, and the AALVee which is an unmanned logistics vehicle for keeping the combat vehicles supplied with ammunition and fuel, AAIMPCLC is a flying armed personnel carrier for up to twelve (12) infantry. Last is the ARMADILLO SHELTER which is not a vehicle, but a mini-fortress that can provide effective protection of infantry soldiers from swarming attacks by enemy owned and operated IPWA embodiment equivalents. The AIMVee could not provide an effective defense against swarming enemy equivalents of the Locust, Firefly and Dragonfly. The AAIMPCLC in the air or on ground is designed to provide an effective defense to fight swarming locusts, fireflies and dragonflies. All of the IPWA embodiments are equipped and able to fight effectively both on the ground and in the air.

Collectively the IPWA embodiments make up a complete fighting force with enough firepower to handle any situation on the battlefield without help from fighter planes, bombers, Stealth, helicopters, main battle tanks, or heavy artillery because it is an objective of this IPWA warfare to make it unnecessary to expose these very expensive weapons to harms way at all. Tanker trucks, supply vehicles, nothing on wheels, even IPWAs have no wheels, because it is also an objective to minimize exposure to IED's or any buried explosives so in IPWA warfare no wheels are on the ground.

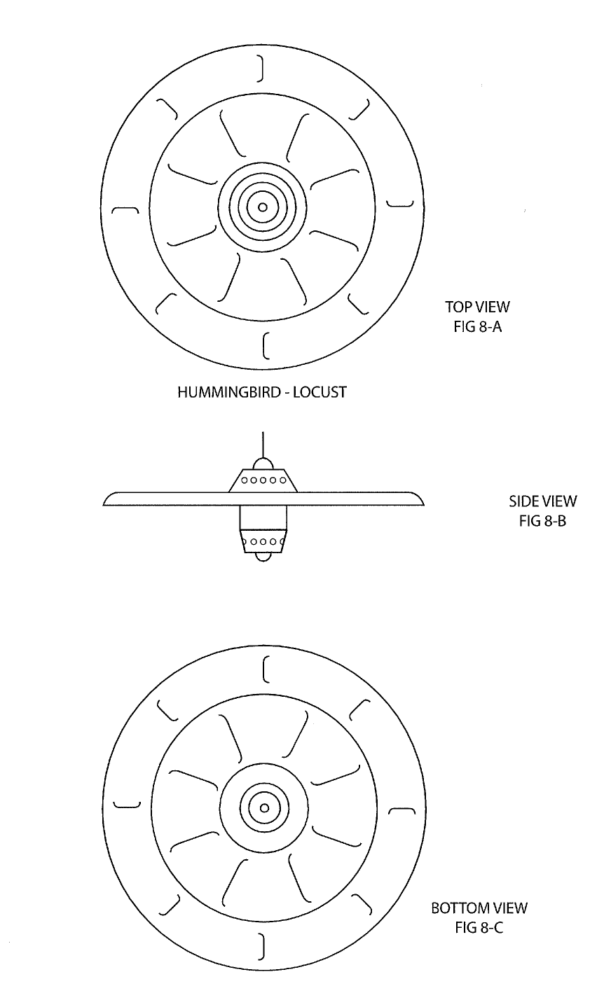

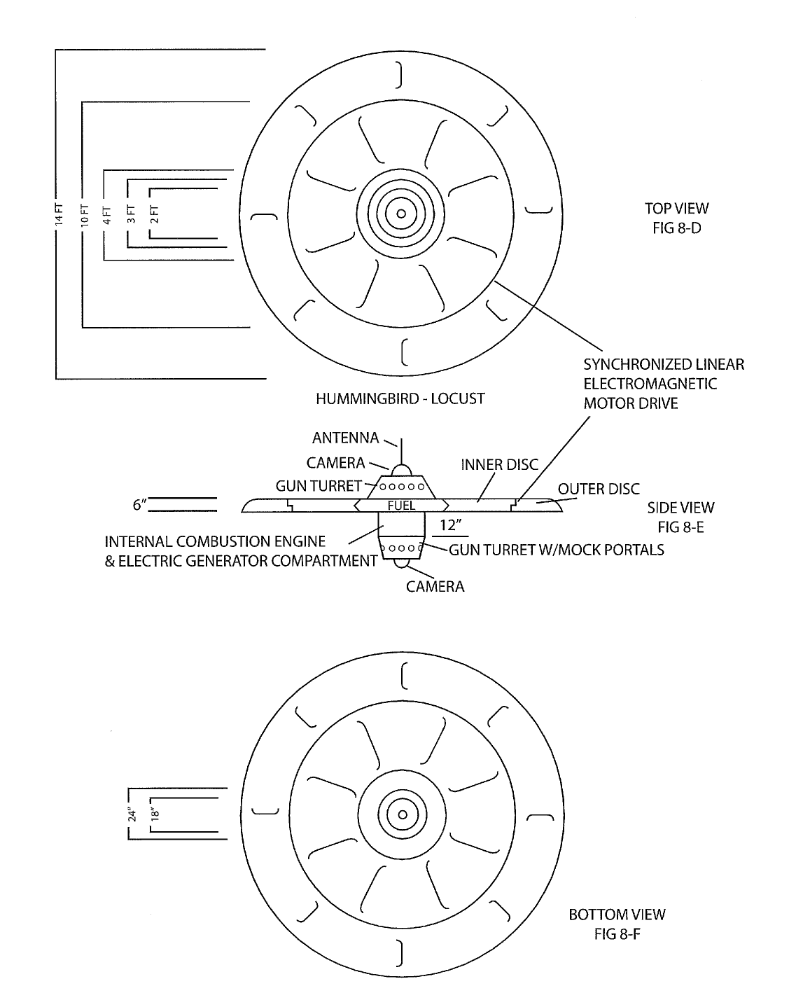

The IPWA LOCUST embodiment FIG. 8 (A-F) is similar to the Guardian except the Locust does not have photovoltaic surfaces on its discs and canopy. The Locust does not have electric energy storage devices in its discs, except it does still have ultracapacitors to give it extra energy if it needs to make a maneuver that requires an extra burst of energy.

The Locust derives its energy from an internal combustion engine using common fuel. However, the Locust has two versions of how it uses this engine. In the first version the engine turns a generator to create electricity that powers the Synchronized Linear Electromagnetic Motor (FIGS. 8-D and 8-E). In the second version the engine drives a transmission that drives mounting arms that propel the outer and inner discs in opposite directions, any torque imbalance adjustments and even directional control, can be made by adjusting the rotation of either discs by varying gear ratios. This can also be accomplished by using two engines instead of one. Each disc is then driven by its own engine and rotation speed is independently controlled. The advantage of the second version is cost. The second version would not require the more costly Synchronized Linear Electromagnetic Motor to drive the discs. The cost of the Locust needs to be kept low and it does not require significant durability because it is likely to have a high rate of casualties compared to the number of hours it will be operated.

In combat this is how the Locust will be used. Like its namesake the primary battle tactic of a Locust is to SWARM on its opponent. Here is an example: Suppose there are 200 insurgents in an open mountainous terrain with large boulders, trees and some hard concrete bunkers. There are also 200 Locusts. All the Locusts see a different part of the field. These pictures are beamed to a blimp some thousands of feet above and forwards the signals to a central common center where there would be several hundred people. Each Locust may have 2 or 3 or more operators. One to operate the vehicle. One to fire the weapons, and one or more to observe the battlefields. When a Locust selects a target and locks on, the big picture screen marks that target in some way so that every other Locust gunner knows that target is taken. Targets that are not taken may be highlighted. This is already existing technology, but the IPWA is a new application. The enemy forces are mostly stationary while Locusts can roam freely over the battlefield.

The entire Locust force may be divided up into squads of any number. A squad of six could focus on a particular part of the battlefield based on the strategy of the overall field commander. That squad then focuses on a target, which may be a bunker or a group of insurgents fighting from behind some rocks. The squad would have a play book of various tactics. They may approach unnoticed from behind a cluster of trees. While one Locust approaches from the front with guns blazing, there are two Locusts coming from either side, one coming from the back side, and two are dropping down vertically from above. This is why it is so difficult to defend against a Locust Swarm. One fires, then another fires, then another fires from various directions, meanwhile no one looks straight up for the Locust coming down from its visual alignment with the sun. It is instinctive to look at the source of a firing weapon. Some Locusts may make more noise than just a firing gun, so as to create a distraction. This is why friendly forces need an Armadillo for protection against any enemy IPWA equivalents because there has to be 360° hemisphere protection from all angles horizontally and at every azimuth and elevation up to vertical, and the ability to return fire in all the same directions. In the case of a Dragonfly in the air it will see and defend itself in a complete spherical field looking at both the ground below, and the sky above for any enemy IPWA equivalents. The Dragonfly is prepared to do this, but it will need several operators in the command control center. The Locust is not a fast vehicle, and is not intended to fly hundreds of miles for a mission. The Locust is not a patrol vehicle, but it is a front line close combat vehicle with extreme maneuverability capability. A Locust may be traveling 30 to 40 MPH in one direction and almost instantly make a 90° change in direction. It may be flying level and suddenly climb vertically. This will make it hard to predict the path of a IPWA.

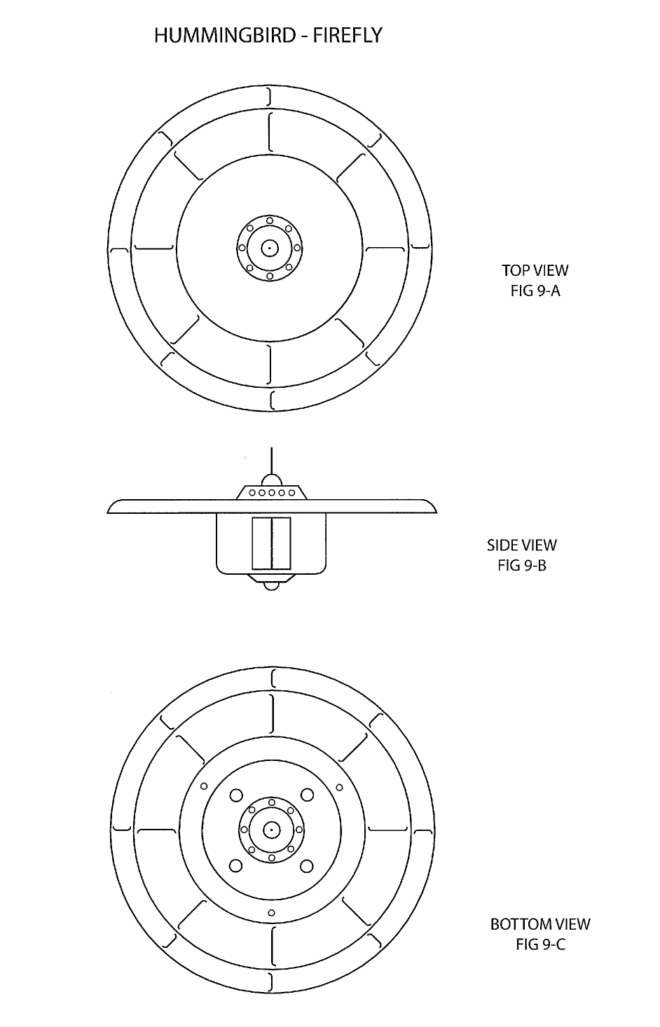

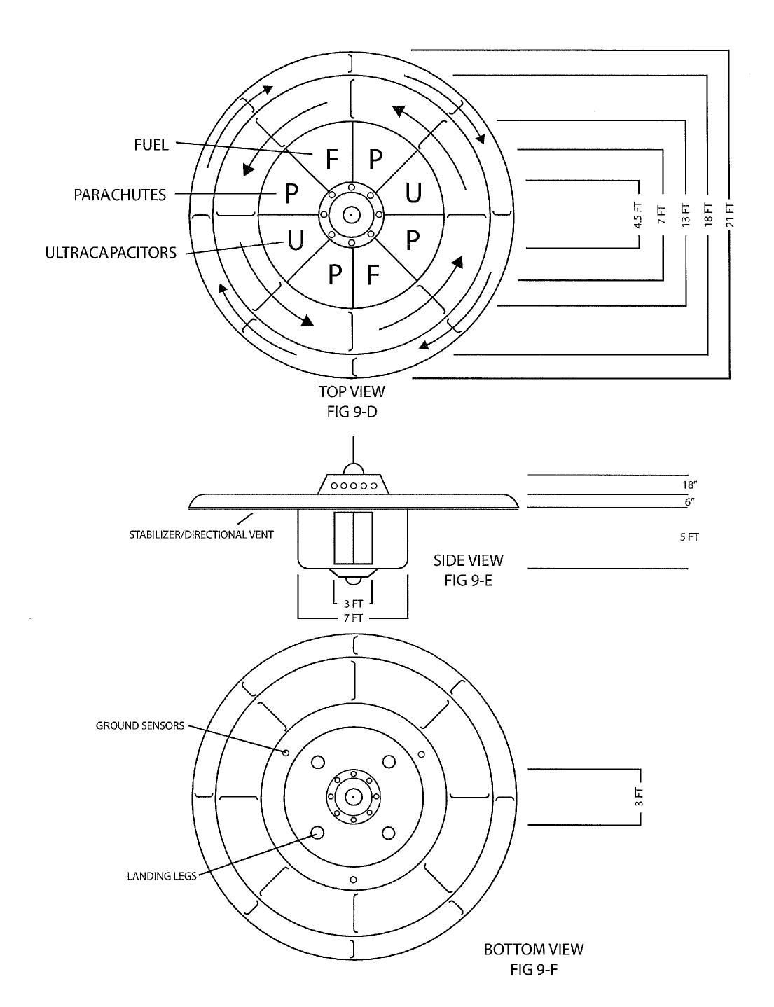

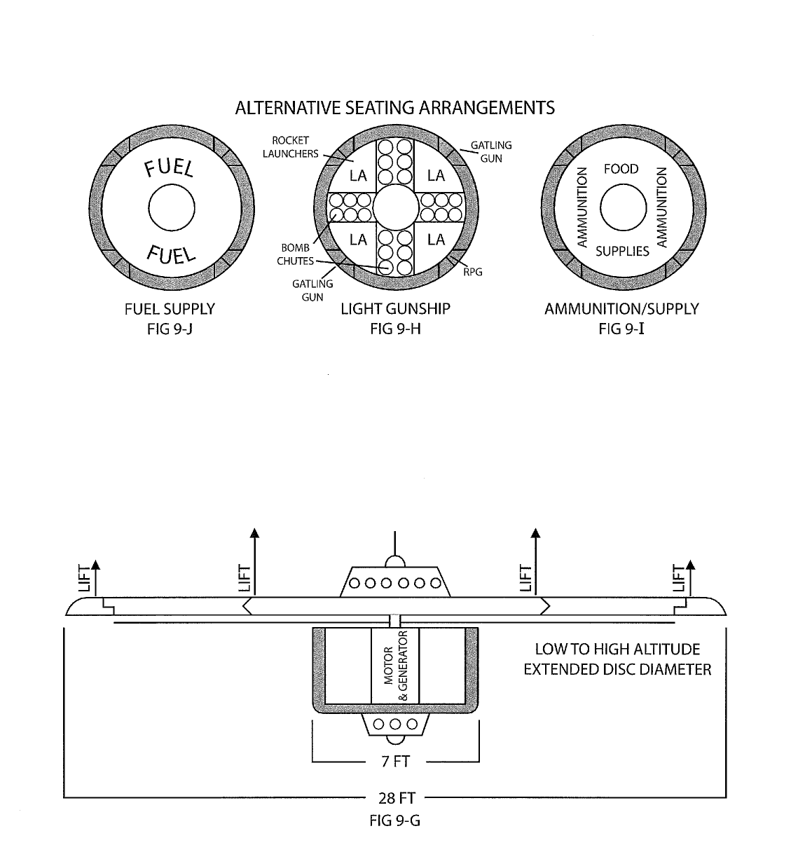

The IPWA FIREFLY shown in FIG. 9 (A-J) is an unmanned version of the IPWA AIMVee which is a flying equivalent of a HUMVee for moving up to four infantry soldiers about on a battlefield or in daily routine missions.

The Firefly flying in a formation with AIMVee's is an effective decoy because enemy soldiers will not be able to tell the difference. The Firefly is equipped as a LIGHT GUNSHIP capable of dropping cluster bombs, launching missiles, firing rocket propelled grenades and rapid firing automatic weapons. Some of these weapons are installed behind the doors and can be used when the doors swing or slide open. This LIGHT GUNSHIP (FIREFLY) would join the swarming LOCUSTS for attacks on heavily fortified enemy positions. The LOCUST has high precision, long range, large caliber, but slow firing anti-personnel weapons, while the Light Gunship can deliver a variety of more powerful weapons. The FIREFLY can also be used to provide logistical support (FIGS. 9-J and 9-I) bringing fuel, ammunition, supplies, food, and small artillery into forward combat positions.

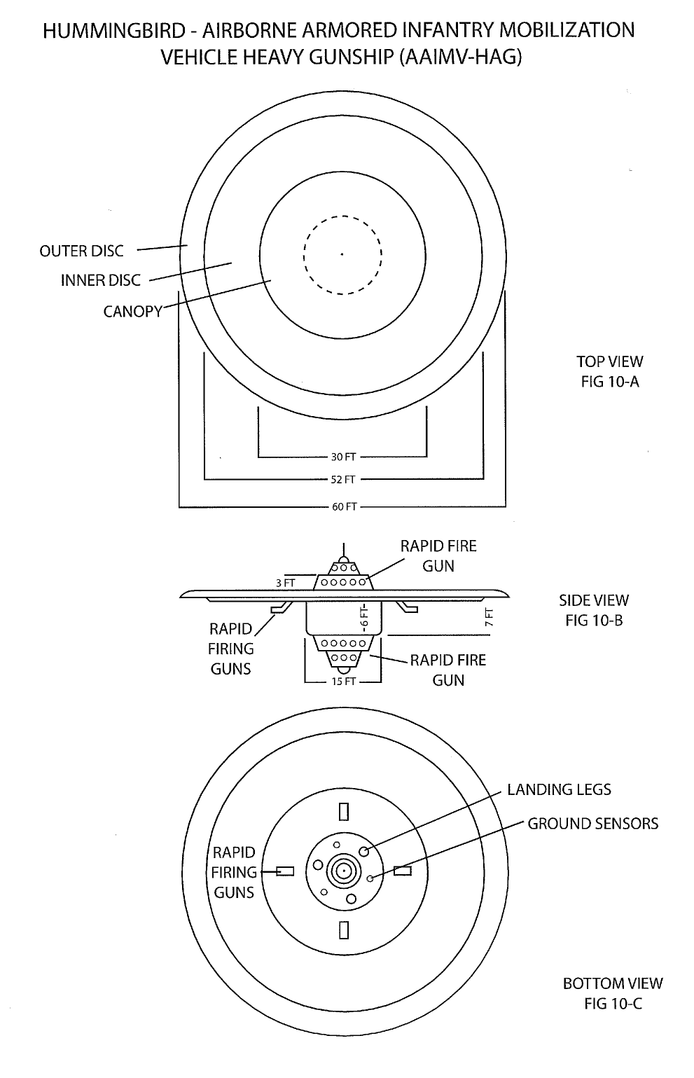

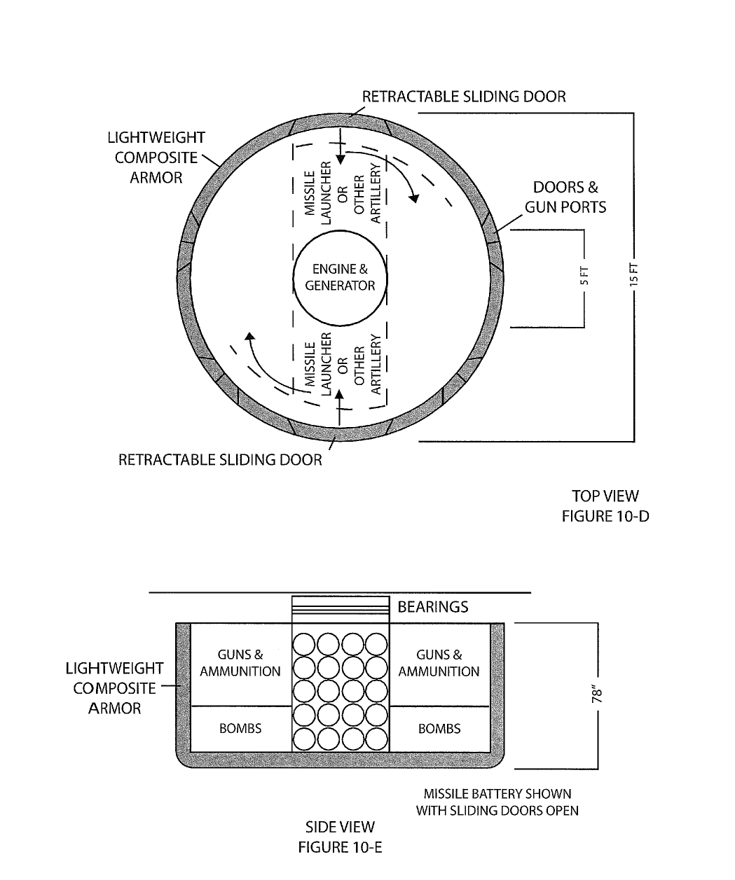

The AIRBORNE ARMORED ARTILLERY MOBILIZATION-HEAVY ARTILLERY GUNSHIP (AAAMV-HAG) FIG. 10 (A-E) is the IPWA equivalent of an M-1 Tank, a Black Hawk Helicopter, or a Jet Fighter Aircraft in terms of destructive fire power capability. For convenience it has been given the nickname DRAGONFLY because like a dragonfly it sees in all directions around itself, and can fly off in any direction. FIG. 10-B shows a double tier of powerful large caliber rapid firing weapons both above the canopy and below the fuselage. FIGS. 10-B and 10-C indicate four smaller caliber rapid firing guns below its canopy. FIGS. 10-D and 10-E shows the body of the gunship containing guided missile launchers concealed behind sliding doors. The Dragonfly carries a variety of missiles, surface to air for when it is sitting on the ground and wants to knock out an enemy jet fighter plane, air to ground for when it is in the air and wants to destroy an enemy vehicle, ground to ground for when it is on the ground wanting to knock out a tank or missile launcher, and air to air for when it is flying and needs to knock down an enemy helicopter. There are dozens of varieties of missiles available. FIG. 10-E indicates the Dragonfly will also carry a variety of bombs, RPG's, more guns and a large supply of ammunition. The Dragonfly body FIGS. 10-D and 10-E is protected by lightweight composite armor. Structurally the Dragonfly is the same as the AAIMPCLC and can also serve as a decoy for the AAIMPCLC when traveling in a formation together, but even as a decoy it will still be a dragonfly.

This completes the description of the three IPWA Vehicles (Locust, Firefly and Dragonfly) that are the unmanned front line combat vehicles. The remaining combat support vehicles are being described separately because they have much broader applications in addition to being in a supporting role during front line combat.

### IPWA-AIMVee

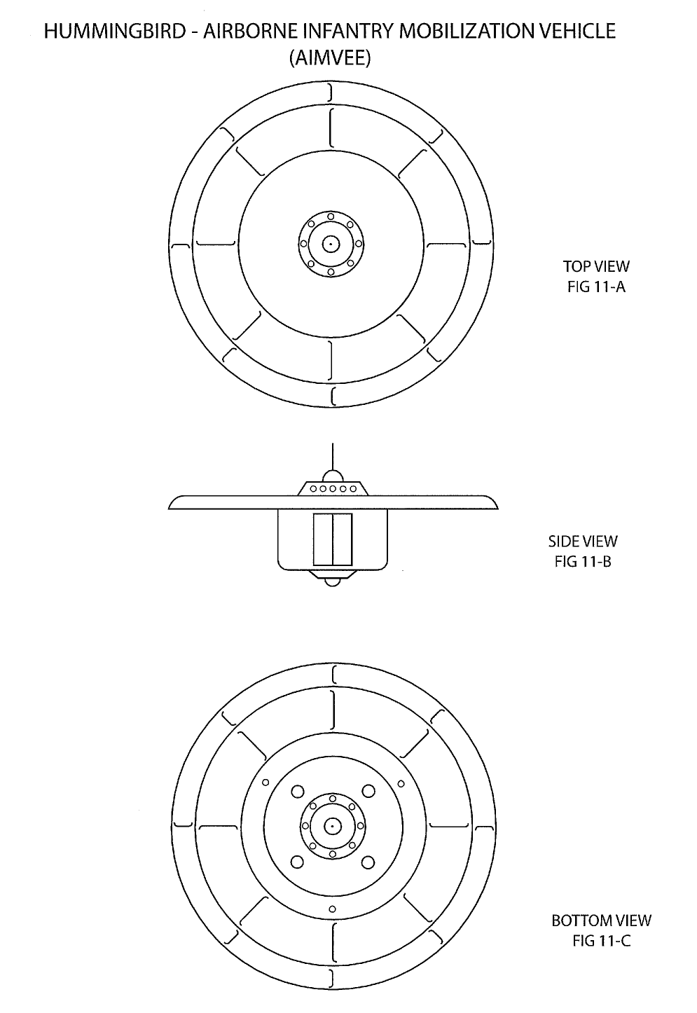

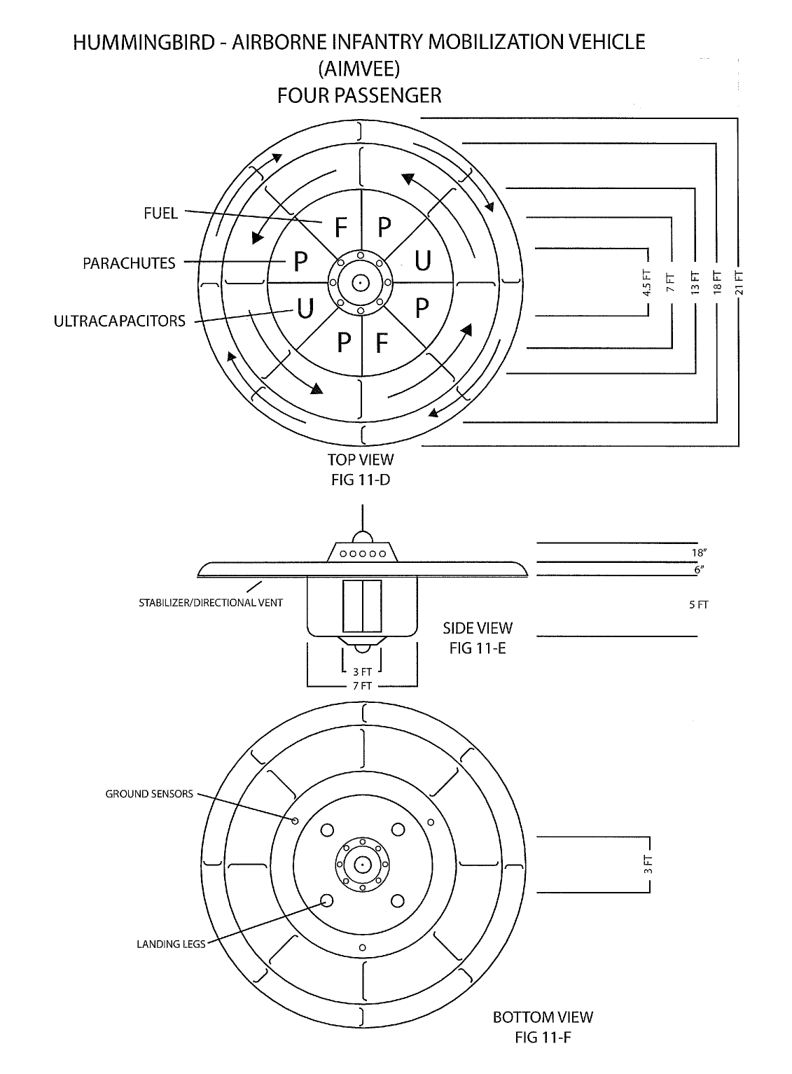

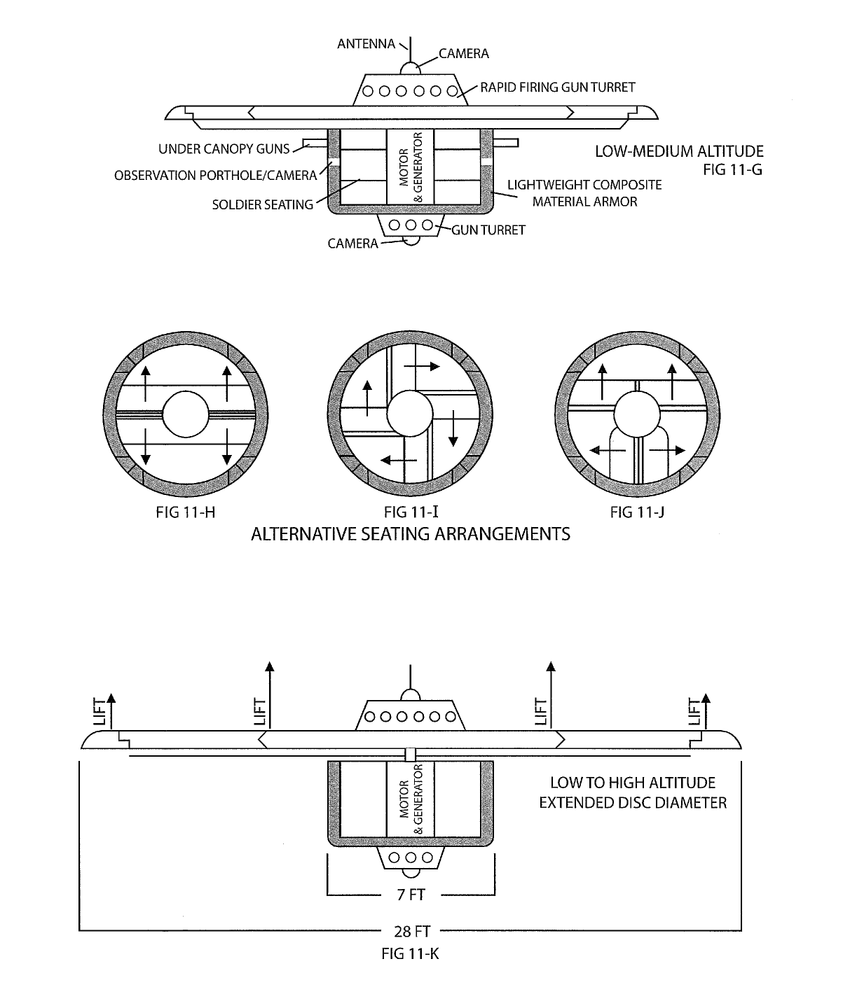

It is the objective of this disclosure to create a series of military vehicles to mobilize infantry as well as to create a vehicle soldiers can use that will be safe from IED's and such other hidden explosives. The IPWA-AIRBORNE INFANTRY MOBILIZATION VEHICLE, hereinafter (AIMVee) FIG. 11 (A-K) is a land based airborne vehicle that requires no special landing facilities and is the primary vehicle for achieving these objectives. AIMVee has no mobility on land because it has no wheels. This is because the objective is a vehicle safe from IED's and other buried explosive devices. If a vehicle has wheels then it will be traveling on the ground thereby exposing it to IED's. This also allows for a vehicle of less weight and a simple tighter design. If wheels are required they can be added. AIMVee is the equivalent of the HUMVEE in most all other ways. The AIMVee is designed as a fully prepared FRONT LINE COMBAT VEHICLE. It is not a vehicle for casual use.

The AIMVee carries four soldiers in various seating configurations FIG. 11 (H) has two soldiers looking front and two looking back, FIG. 11(I) has each soldier looking in a different direction, one front, one right, one behind, and one left, FIG. 11 (J) has two soldiers looking front, one looking left and back, one looking right and back. Each soldier has a door FIGS. 11 (B, H, I, & J). The doors open automatically from the center. The doors close automatically and quickly, behind the soldier, when they jump back in the vehicle. The doors are in the same location in all configurations allowing each vehicle to use any preferred seating arrangement. The personnel compartment is encased in a thick cocoon of lightweight composite armor FIG. 11G. The personnel compartment is shaped like a pot. The entire bottom has the heaviest armor and the entire circumference is armored. In current armored Humvees the bottom is not armored only the sides and the doors jamb in a fire. As shown in FIG. 11B the doors have no windows. Windows are a design option. If windows are required, they can be added. Without windows or one-way view glass, the enemy cannot see the soldiers inside. The enemy has no idea how many are inside, or if there are any soldiers inside at all.

The AIMVee personnel compartment receives FILTERED air conditioned ventilation designed to remove any potential biohazards, toxic gases, toxic fumes from burning buildings, micro dust particles in the air that infiltrate lungs, or exploding chemicals, and to protect the crew against extreme outside temperatures. Observation portals and cameras are suggested in lieu of windows, see FIG. 11G, with video screens positioned near the side of each door so each soldier can see what is outside. Each camera is slaved to an automatic rapid fire gun located near the top of the personnel compartment just under the canopy FIG. 11G. These guns can be fired automatically by remote operators, but the soldier in the vehicle could override the remote operator. As shown in FIG. 11G there are full 360° panoramic cameras looking up above the canopy and down at the ground. An antenna transmits these pictures, and those taken by the cameras located at the soldier stations to a remote location. This location would have a large number of spotters and gunners actively participating while the vehicle is on a mission. They operate the gatling guns above and below the personnel compartment. These spotters and gunners will also be coordinating deployment and control over any unmanned AIMVee LIGHT GUNSHIPS (Fireflies) or LOGISTICAL SUPPORT VEHICLES involved in the same operation. The soldiers inside the AIMVee may also have video screens inside that shows the same 360° panoramic views the observers are seeing.

Soldiers in a hostile territory would always travel in an AIMVee even it if is a friendly meeting with elders, a road block, or escorting visitors around. The AIMVee should stay 20 to 30 feet above the ground to keep it safe from IED's. The AIMVee does not have to follow the road. The AIMVee is vulnerable to missiles, but the enemy does not know which one has soldiers, or if any have soldiers. Fireflies in the formation will also serve as decoys. As the AIMVee ascends to higher elevations the infantry will have a better view of enemy positions.

When the AIMVee and its soldiers arrive at their destination, presumably the soldiers will have to leave the protection of the vehicle compartment. However, the AIMVee will still have their backs covered. While the soldiers may be distracted by the activities of the mission, the AIMVee will not be distracted. The remote observers will be watching up and down, in all directions for any threatening activity. They are in a position to audibly warn the soldiers of danger and can fire weapons from the unoccupied vehicle. If the soldiers are forced to move away from their vehicle suddenly, they could find themselves several hundred feet away from the safety of the AIMVee. The soldiers or spotters in off-site secure locations can activate the vehicle to start up and fly to their position to pick them up.

The AIMVee overcomes many of the inherent obstacles that interfere with HUMVEE performance and mobility. Whether travelling one (1) foot or twenty (20) feet above the ground the AIMVee is not delayed by loose sand, several feet of snow, ice on roads, rain saturated roads, marshland, rock slides, rough terrain, or mountain roads that are too narrow. The AIMVee can cross ditches, creeks, rivers, canyons, fences, razor wire, concrete barricades, walls, buildings, trees, tank trenches or any barrier whenever or wherever necessary. IED's and small arms fire are minimal threats to the soldiers protected inside an AIMVee. The AIMVee has weapons on board that can be used against an enemy without exposing the soldiers to direct fire.

The IPWA AIMVee would be powered with about a 300 HP turbine engine turning a generator to create electricity to supply power to the synchronized linear motors driving the discs. The engine exhaust heat and muffled sounds of the engine are vented through the central axle and discharged just above the canopy so the heat and sound are less noticeable from the ground. There is no thin film photovoltaic solar collector, and no batteries inside the discs for storing energy. However, there are ultracapacitors on board.

The AIMVee Canopy, FIG. 11-D, provides several safety precautions for the vehicle. The fuel to operate the turbine is stored overhead in the canopy. The personnel compartment protects most of the canopy from gunfire. The canopy also contains parachutes that can be released if the vehicle is high enough off the ground and there is an engine failure. The parachutes will stabilize and slow the descent of the vehicle. In such an emergency the personnel compartment can be released to drop several feet below the canopy on cables so the vehicle maintains a controlled descent. In the event the AIMVee is just a few hundred feet in the air, and there is an engine failure making the parachutes less effective then the ultracapacitors on board have sufficient capacity to operate the synchronized linear motor until the vehicle safely reaches ground. If an AIMVee finds itself in an ambush then the power in the ultracapacitors can be combined with the power and thrust of the turbines to make a more rapid escape. If there is an engine failure in a non secure location the ultracapacitors can keep the AIMVee airborne long enough to move it to a more secure location.

The AIMVee is being illustrated in two disc diameter sizes. The AIMVee shown in FIGS. 11 (A & D) has a 21 foot outside diameter to enable the vehicle to get into tighter spaces. The discs will have to rotate faster and the engine may have to work harder. This vehicle will be more suitable for low to medium altitude. In FIG. 10K the AIMVee is shown with an outer disc diameter of 28 feet which will make this vehicle more suitable for high altitudes. FIG. 10K also illustrates an important design requirement for all IPWAS. The outer disc provides greater upward lift than the inner disc. The inner ring of the outer disc has a lower lip to support bearings that allows the outer disc to lift the outer edge of the inner disc. The inner ring of the inner disc also has a lower lip to support bearings that provide lift against the outer ring of the canopy. The canopy is attached to the central axis that is the backbone of all IPWAs. The canopy prevents the air compressed below the discs from escaping through the DONUT HOLE that is blocked by the canopy. The discs are lightweight but rigid across the width of the disc. This outer disc to inner disc to canopy uplifting force allows the spokes to support mostly a radial load from their central axle and allows the Stabilizer/Directional Vent to be positioned closer to the rotating discs which increases the effectiveness of the vent.

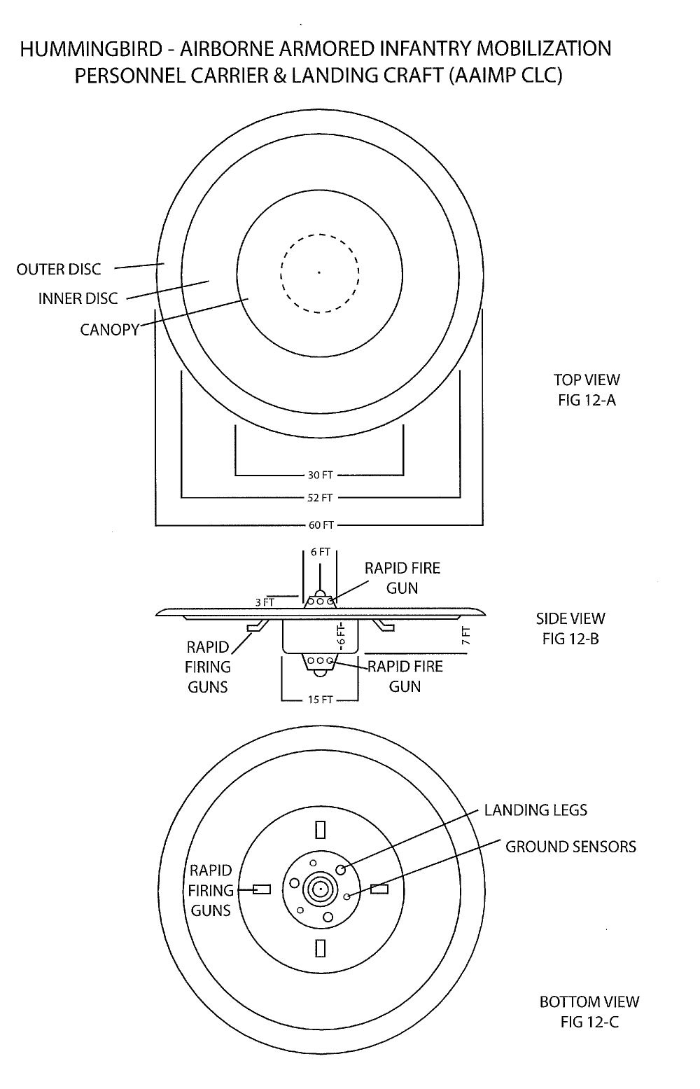

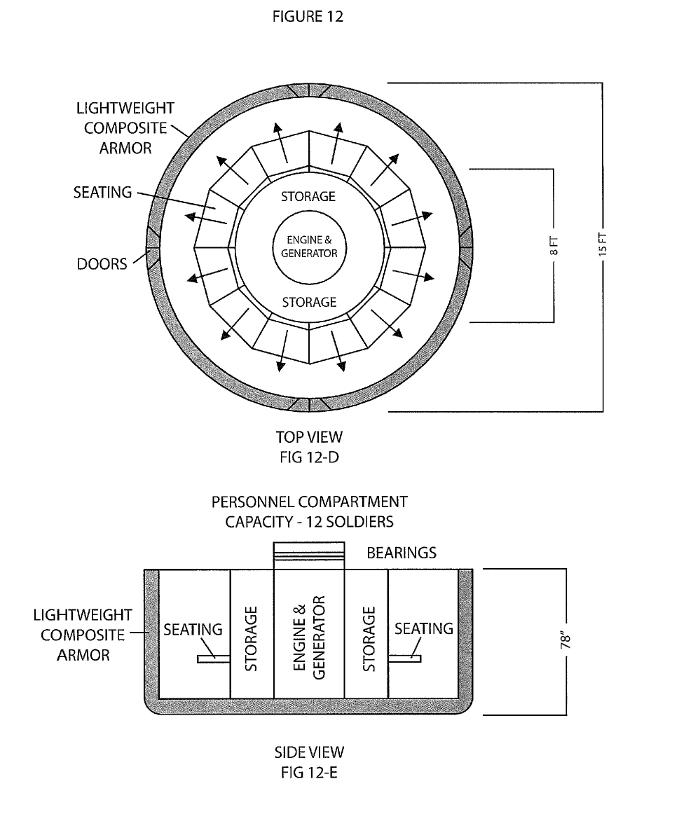

Another IPWA embodiment used to mobilize infantry is the IPWA-AIRBORNE ARMORED INFANTRY MOBILIZATION PERSONNEL CARRIER & LANDING CRAFT hereinafter (AAIMPCLC) FIG. 12 (A-E).

The IPWA AAIMPCLC is an armored personnel carrier seating up to 12 soldiers PLUS some supplies as shown in the illustration FIGS. 12 (D & E). This vehicle has all the features and amenities as the AIMVee. The only real difference is in the size and potential missions for these two embodiments. As an armored personnel carrier the AAIMPCLC may be used to shuttle troops forward as the LOCUST, AIMVee LIGHT GUNSHIP and AAAMV-HAG advance on the front line. On the other hand, the AAIMPCLC could be used as a troop transport flying at high altitude over hundreds of miles. The AAIMPCLC can also be used for evacuation of civilians during some local political crisis.

As a LANDING CRAFT the AAIMPCLC could be used for amphibious landings to establish beach heads or break down a line of enemy fortifications.

The AAAMV-HAG (Dragonfly) would lead the amphibious landing or an attack on fortifications until the defenses are no longer effective. Then the AAIMPCLC personnel carrier landing craft would follow. However, unlike past amphibious landings with hovercraft and landing boats, and soldiers being shot in the water and a few staggering ashore to establish a beachhead as during the Normandy invasion. Those days are gone. The AAIMPCLC will simply fly above the water, beaches, bluffs, fortifications and continue inland several miles to the designated landing zones. This could eliminate or minimize the need for soldiers to drop in by parachute. Then the IPWA GUARDIANS would come in to establish a perimeter. LOCUSTS and Fireflies could start scouting and attacking beyond the established GUARDIAN perimeter. Shallow 4 to 6 foot deep foot diameter holes could be mechanically excavated to allow the AAAMV-HAGs (Dragonflies) to dig in to create fortified positions or Armadillos could be put in place. This would allow supply vehicles FIG. 9-J and FIG. 9-I to bring in more ammunition, fuel, supplies, and food.

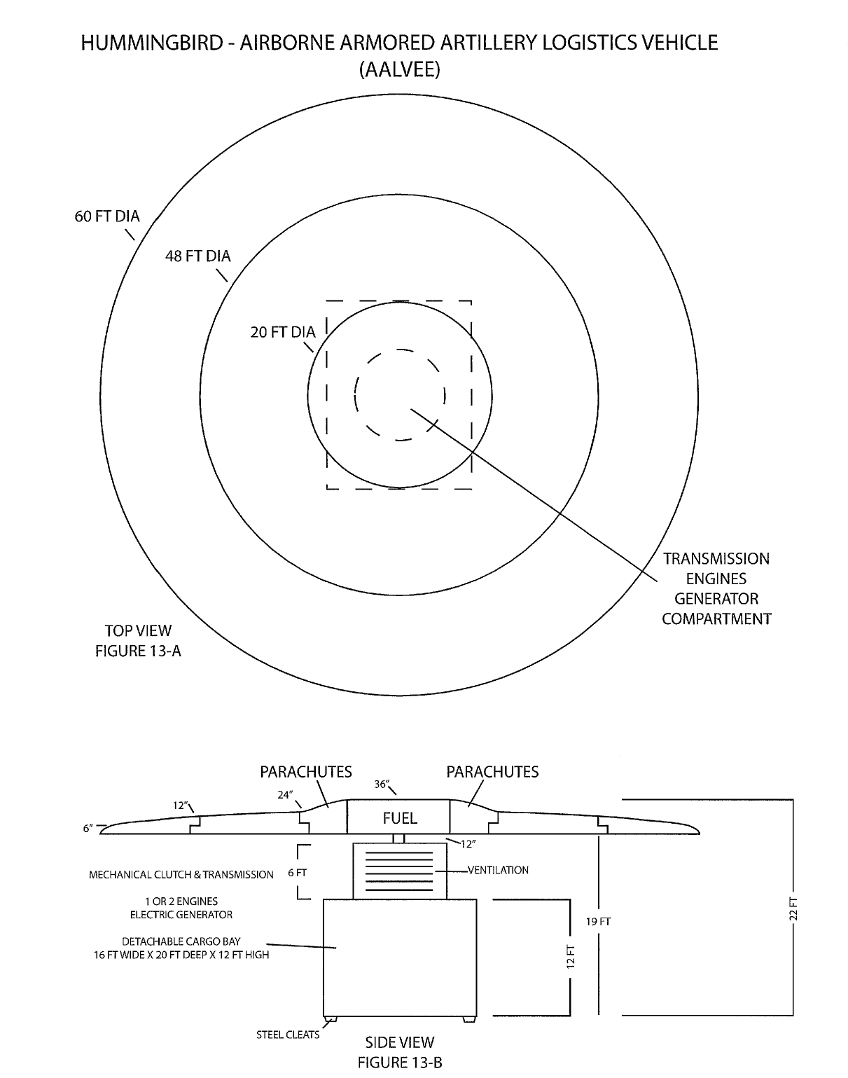

The IPWA-AIRBORNE ARTILLERY LOGISTICS VEHICLE (AALVee) FIG. 13 is a powerful heavy lifting vehicle designed to bring in heavy artillery, missile launchers, fuel, ammunition, vehicles, food and supplies in large quantities. It is expected to have a GVW of maybe 30,000 to 40,000 pounds it can be built in a wide range of sizes.

The above may have as many as three powerful internal combustion engines. One to drive an electric generator to generate electricity for the Synchronized Linear Electric Motors, and one to drive each of the counter rotating discs.

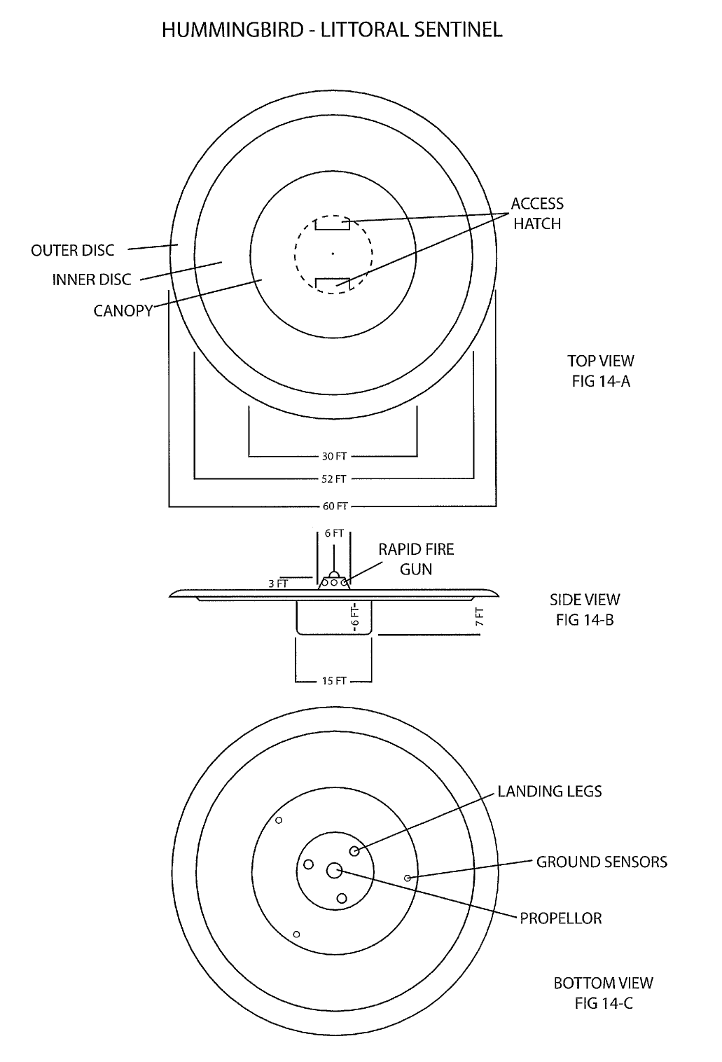

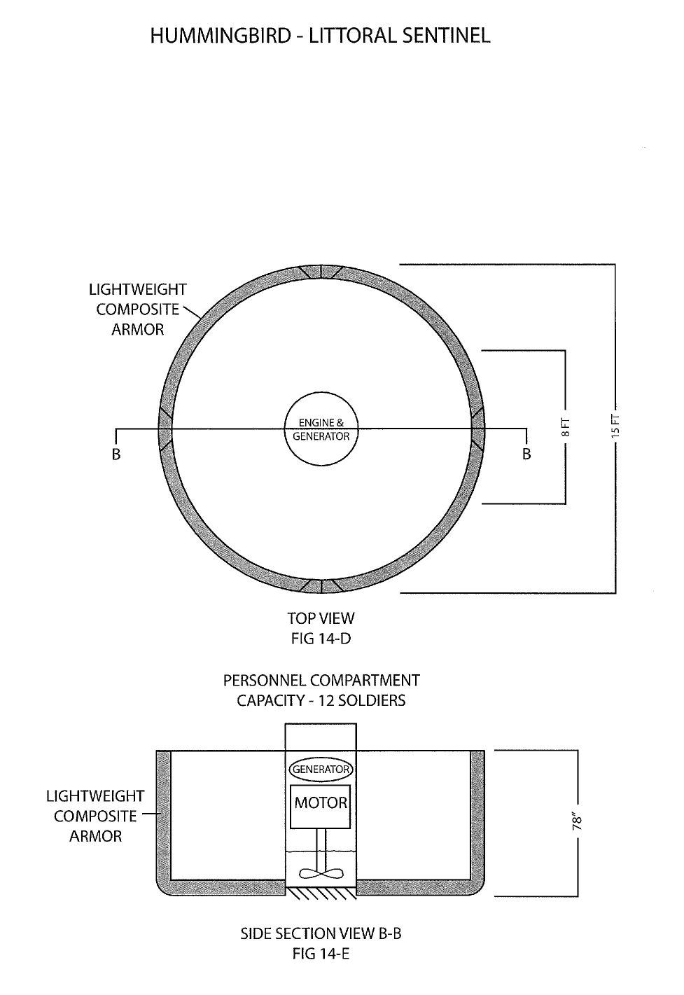

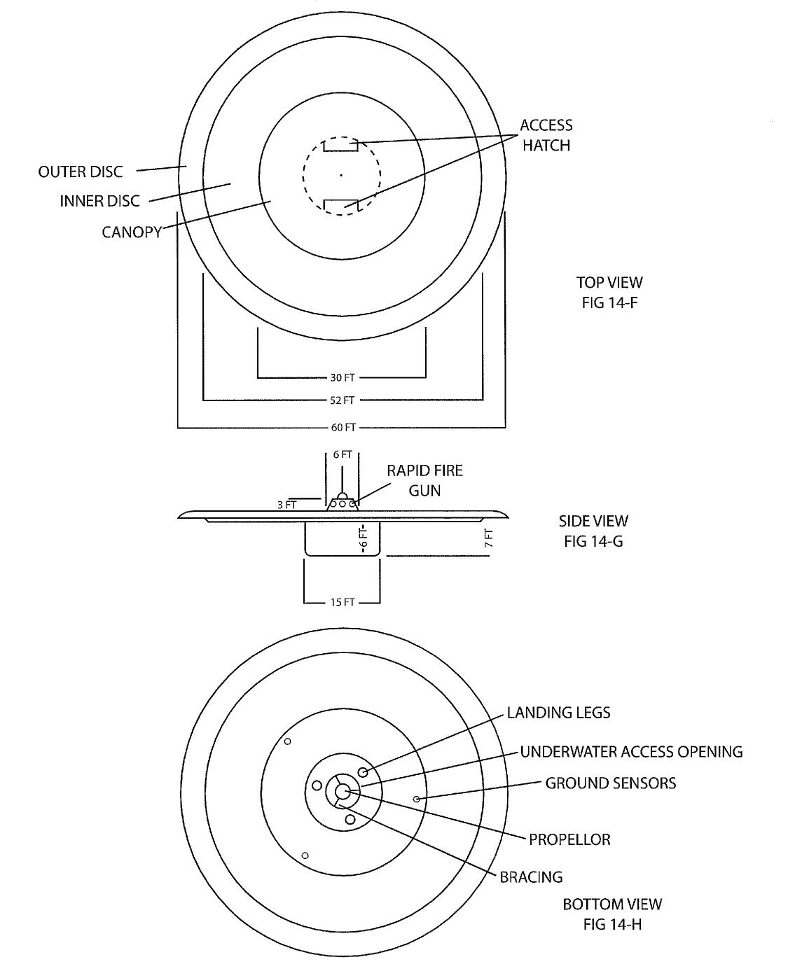

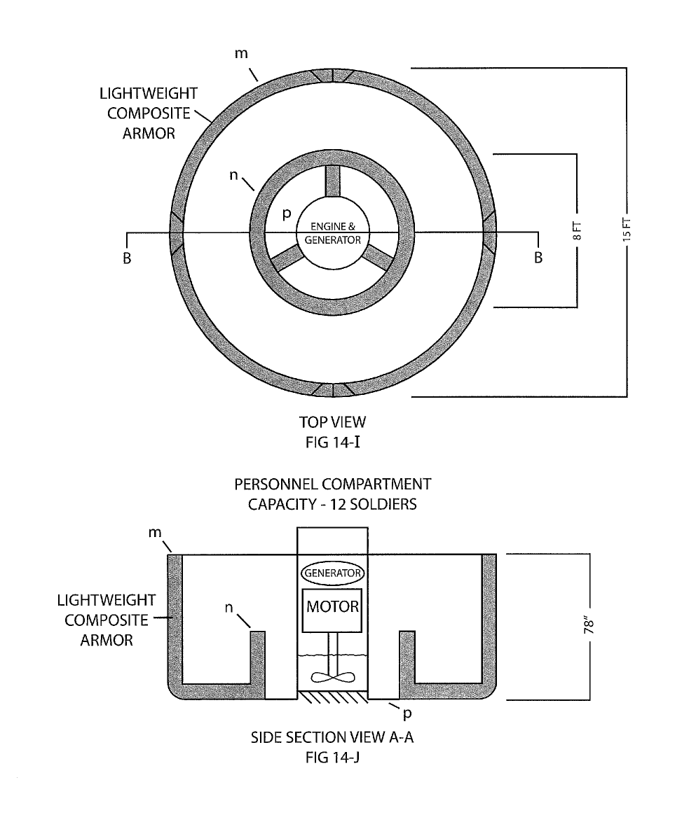

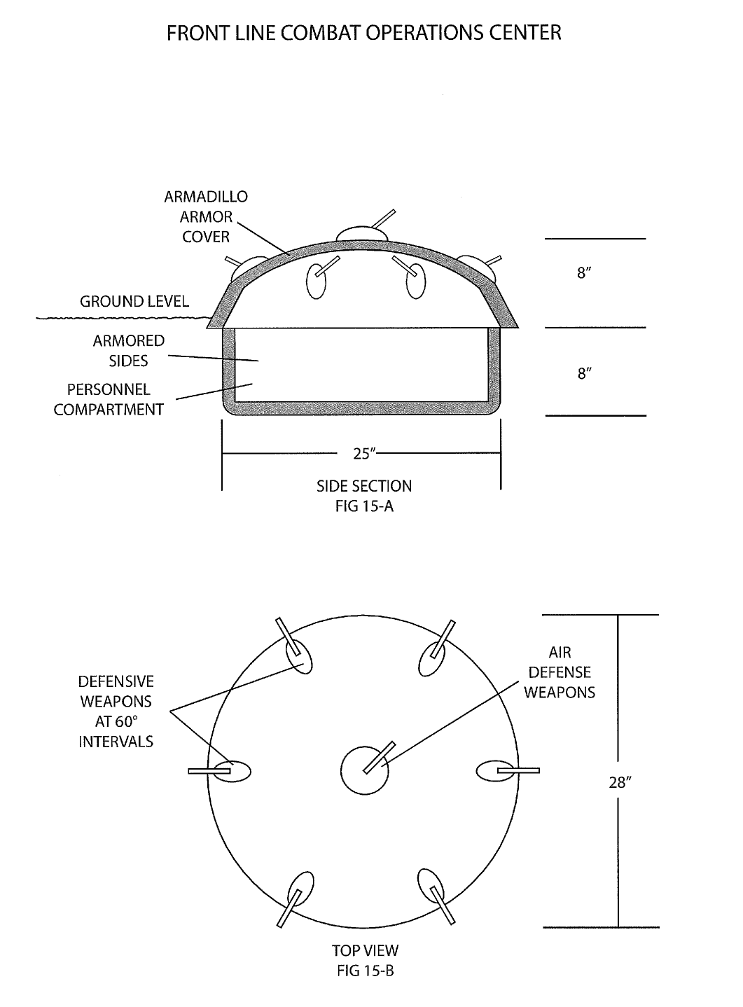

The IPWA-Littoral Sentinel (FIG. 14) as shown is similar in size and appearance to the AAIMPCLC. The Littoral Sentinel may be a manned or unmanned vehicle. The navy has littoral ships that are about the size of guided missile frigates. They are used for launching one or two helicopters, to launch small boats, and to deliver a small assault force. The ship is designed for speed and shallow draft. The Littoral Sentinel actually is what the Littoral Ship does. The Littoral Sentinel can fly as a helicopter, travel on water, land an assault force on land, as well as, fight on land. The Littoral Sentinel could be used for anti-submarine detection, mine countermeasures, mine sweeping, sonar sweeps, intelligence, surveillance, reconnaissance, homeland defense, maritime intercept of pirates, drug smugglers, other criminal activities, and for water rescue operations. The Littoral Sentinel can cruise up rivers and slowly drift back down. With such a shallow draft the Littoral Sentinel can work its way into swamps and marshlands where only airboats might venture to go. The Littoral Sentinel can go almost anywhere and would likely be the only military vehicle capable of operating and fighting on land, in the air, or on water.

FIG. 14 (A-C) the Littoral Sentinel shows the standard characteristics of other IPWAs. FIG. 14-A shows access hatches from the above canopy, but other access in the hull can be made as conditions require. The hull would be light composite armor and waterproof. The ground (or water) sensors are moved up on the canopy in FIG. 14-C. In FIG. 14-E an internal combustion engine (motor) is shown for driving the electric generator, the rotating inner and outer discs can move the vehicle while in the water, or the motor may disconnect from the generator and engage a propeller or blade that is below the water line and either move the craft by using directionally variable vents (as shown) or put a propeller in the water like a small power boat (not shown) the discs would not be rotating. In FIGS. 14 (D and E) the hull is shown open for whatever applications the navy or coastguard requires. In FIG. 14-J there is a full height hull wall m, and a partial hull height n, and an open area “p” to allow navy seals or special forces to get in and out of the boat, or lower equipment without exposure to outside observers. The navy is not pleased with the Littoral Ships it has designed and had delivered for about $450 million each. None are expected to be survivable in a hostile combat environment. The Littoral Sentinel is capable of individually performing any one function required. Littoral Sentinels will cost in the range of a helicopter or about 27 each of the cost of a Littoral Ship. While it would require several Littoral Sentinels to do all the activities of a Littoral Ship, they would be more survivable because they are disbursed, and more functional because they could be spread out over a larger area and performing several functions simultaneously.

Here is an example: manned and unmanned Littoral Sentinels could sit right off the shore to watch Somali Pirates. It could follow them out to sea and right back to shore, follow them over land all the way to their front (or back) yard. Littoral Sentinels could fly to get to a situation faster than a boat, but get down in the water at eye level to intercept and engage them. The Sentinels can attack the pirates from the AIR, WATER or on LAND.

Some Littoral Sentinels may need photovoltaic surfaces, and energy storage devices, much like the IPWA Guardian, because it will be doing a lot of patrol duty and sitting around doing nothing for extended periods. This is where unmanned Sentinels will have an advantage. The Littoral Sentinel is consistent with the navy goal to “unman the front lines”. It is an objective of all the IPWA vehicles to unman the front lines, especially in situations where friendly soldiers have no significant unfair technological leverage over their enemy in a fight.

The Front Line Combat Operations Center could be divided into bottom and top sections and flown in by ALVEE vehicles. If the enemy forces have IPWA type vehicles available to them then this type of shelter would be effective in protecting personnel on the ground.

In this invention all the known external and internal aeronautic forces are taken into consideration. The generalized Stabilizer Directional Vent can control all or most IPWA embodiments.

The IPWA embodiment improves upon the prior art by using the outer contra rotating disc to transfer its lifting forces to the inner center rotating disc which then transfers the combined lifting forces of both discs to the outer edge of the non-rotating CANOPY that covers the APERTURE in the prior art. The covered aperture increases lift by preventing higher pressure air under the canopy from escaping through the aperture. The outer and inner rotating discs are still stabilized by mounting arms or spokes to a triple concentric bearing collar attached around the central axle. The IPWA uses the GENERALIZED STABILIZER/DIRECTIONAL VENT to control the vehicle.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. An unmanned aircraft with improved directional controls, the unmanned aircraft being controlled from a central control center, the aircraft comprising:
a first outer disc having inner and outer peripheral edges, the outer disc adapted for rotation in a first direction;
a second inner disc having inner and outer peripheral edges, the inner disc adapted for rotation in a second direction that is opposite to the first direction;
an electromagnetic motor positioned between and interconnecting the inner peripheral edge of the outer disc and the outer peripheral edge of the inner disc, the electromagnetic motor driving the outer disc in the first direction and the inner disc in the second direction;
a canopy interconnected to the inner peripheral edge of the inner disc, the canopy including communication means for communicating with the central control center;
lifting vents formed within the inner disc and adapted to direct air flowing over the inner disc downwardly in order to generate lift;
armaments located within the canopy.

2. An aircraft with improved directional controls comprising:
a first outer disc having inner and outer peripheral edges, the outer disc adapted for rotation in a first direction;
a second inner disc having inner and outer peripheral edges, the inner disc adapted for rotation in a second direction that is opposite to the first direction;
a motor positioned between and interconnecting the inner peripheral edge of the outer disc and the outer peripheral edge of the inner disc, the motor driving the outer disc in the first direction and the inner disc in the second direction;
a canopy interconnected to the inner peripheral edge of the inner disc, the canopy including communication means.

3. The aircraft as described in claim 2 wherein the aircraft is unmanned.

4. The aircraft as described in claim 2 wherein the canopy includes wireless communication means for communicating with a central control center.

5. The aircraft as described in claim 2 further comprising lifting vents formed within the inner disc and adapted to direct air flowing over the inner disc downwardly in order to generate lift.

6. The aircraft as described in claim 2 further comprising armaments located within the canopy.

7. The aircraft as described in claim 2 wherein the outer disc has a diameter of approximately 14 feet.

8. The aircraft as described in claim 2 wherein the aircraft is manned and the canopy includes a crew compartment.

9. The aircraft as described in claim 2 wherein ground sensors are positioned upon the underside of the inner disc to permit the aircraft to travel in close proximity to the ground.

10. An aircraft with improved directional controls comprising:
a first and second concentrically located counter rotating discs, each disc having inner and outer peripheral edges;
the inner peripheral edge of the outer disc being interconnected to the outer peripheral edge of the inner disc;
a motor for rotating the first and second discs in opposite directions;
lifting vents formed within the inner disc and adapted to direct air flowing over the inner disc downwardly to generate lift.

11. The aircraft as described in claim 10 wherein the aircraft is unmanned.

12. The aircraft as described in claim 10 wherein the aircraft includes a stationary canopy mounted along a central axis.

13. The aircraft as described in claim 12 further comprising wireless communication means or communicating with a central control center.

14. The aircraft as described in claim 12 further comprising armaments located within the canopy.

15. The aircraft as described in claim 10 wherein the outer disc has a diameter of approximately 14 feet.

16. The aircraft as described in claim 10 wherein the aircraft is manned and further comprising a central canopy with a crew compartment.

17. The aircraft as described in claim 10 wherein ground sensors are positioned upon the underside of the inner disc to permit the aircraft to travel in close proximity to the ground.

18. The aircraft as described in claim 10 wherein the inner and outer discs are interconnected by synchronized linear electromagnetic motors.

19. The aircraft as described in claim 18 wherein batteries are stored within the inner and outer discs and further wherein the batteries power the electromagnetic motors.
